(19) United States
(12) Patent Application Publication
(10) Pub. No.: US 2020/0047687 A1
(43) Pub. Date: Feb. 13, 2020

(54) EXTERIOR SPEECH INTERFACE FOR VEHICLE

(71) Applicant: SF Motors Inc., Santa Clara, CA (US)

(72) Inventors: Jaime Camhi, Santa Clara, CA (US); Avery Jutkowitz, Santa Clara, CA (US)

(21) Appl. No.: 16/101,021

(22) Filed: Aug. 10, 2018

(51) Int. Cl. B60R 11/02; G10L 15/22; B60R 16/02; G06F 3/16

(52) U.S. Cl. CPC B60R 11/0247; G10L 15/22; G10L 2015/223; G06F 3/167; B60R 16/02

(57) ABSTRACT

Provided herein are systems and methods to control vehicular functions using voice commands that originate outside vehicles. A plurality of microphones can be disposed on an exterior of a vehicle, and can detect a voice command from a user located outside the vehicle. The voice command can include an activation phrase followed by an operational command. The at least one of the plurality of microphones can activate, responsive to the detection, a speech module of the vehicle from a low-power mode. The speech module can authenticate the user according to the activation phrase of the voice command, and can determine a vehicular function corresponding to the operational command of the voice command. The speech module can cause the vehicle to provide an indicator to acknowledge the operational command. The speech module can activate an electronic control unit (ECU) that corresponds to the vehicular function, to perform the vehicular function.

### BACKGROUND

Vehicles such as automobiles can perform vehicle operations that can be initiated by a driver or passenger through controls and buttons incorporated in the cabin area.

### SUMMARY

The present disclosure is directed to systems and methods for controlling vehicular functions using voice commands that originate outside vehicles. A vehicle, which can include semi-autonomous or autonomous vehicle, can provide a voice command interface that is accessible from an exterior of the vehicle. The voice command interface can include a plurality of microphones disposed on an exterior of a vehicle, through which enrolled or authorized users can initiate various vehicular functions without entering the vehicle or using a remote-control device for instance. The vehicular functions can include control of car locks, windows, heating, ventilation and air-conditioning (HVAC) features for instance, as well as semi-autonomous or autonomous driving operations such as self-parking, self-charging and passenger pick-up.

At least one aspect is directed to a system to control vehicular functions using voice commands that originate outside vehicles. The system can include at least one of a plurality of microphones disposed on an exterior of a vehicle. The at least one of the plurality of microphones can detect a voice command from a user located outside the vehicle. The voice command can include an activation phrase followed by an operational command. The at least one of the plurality of microphones can activate, responsive to the detection, a speech module of the vehicle from a low-power mode. The speech module can have a processor and a memory storage unit. The speech module can execute the processor and use the memory storage unit to authenticate the user according to the activation phrase of the voice command. The speech module can determine a vehicular function corresponding to the operational command of the voice command. The speech module can cause the vehicle to provide an indicator to acknowledge the operational command, responsive to authenticating the user. The speech module can activate, responsive to authenticating the user, a first electronic control unit (ECU) of a plurality of ECUs of the vehicle that corresponds to the vehicular function, to perform the vehicular function.

At least one aspect is directed to a method to control vehicular functions using voice commands that originate outside vehicles. The method can include detecting, by at least one of a plurality of microphones disposed on an exterior of a vehicle, a voice command from a user located outside the vehicle, the voice command comprising an activation phrase followed by an operational command. The method can include activating, responsive to the detection, a speech module of the vehicle from a low-power mode of the speech module. The method can include authenticating, by the speech module, the user according to the activation phrase of the voice command. The method can include determining, by the speech module, a vehicular function corresponding to the operational command of the voice command. The method can include providing an indicator to acknowledge the operational command, responsive to authenticating the user. The method can include activating, by the speech module responsive to authenticating the user, a first electronic control unit (ECU) of a plurality of ECUs of the vehicle that corresponds to the vehicular function, from a low power mode of the first ECU to perform the vehicular function.

At least one aspect is directed to a vehicle. The vehicle can include at least one of a plurality of microphones disposed on an exterior of the vehicle. The at least one of the plurality of microphones can detect a voice command from a user located outside the vehicle. The voice command can include an activation phrase followed by an operational command. The at least one of the plurality of microphones can activate, responsive to the detection, a speech module of the vehicle from a low-power mode. The speech module can have a processor and a memory storage unit. The speech module can execute the processor and use the memory storage unit to authenticate the user according to the activation phrase of the voice command. The speech module can determine a vehicular function corresponding to the operational command of the voice command. The speech module can cause the vehicle to provide an indicator to acknowledge the operational command, responsive to authenticating the user. The speech module can activate, responsive to authenticating the user, a first electronic control unit (ECU) of a plurality of ECUs of the vehicle that corresponds to the vehicular function, to perform the vehicular function.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example system to control vehicular functions using voice commands that originate outside vehicles;

FIG. 2 is a flow diagram of an example method to control vehicular functions using voice commands that originate outside vehicles; and

FIG. 3 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of controlling vehicular functions responsive to an audio input such as a voice command that originated from outside the vehicle. The various concepts introduced above and discussed in greater detail below may be implemented in any of numerous ways.

Described herein are systems and methods to control vehicular functions using voice commands that originate outside vehicles. A vehicle, which can include electric, hybrid, fossil fuel, hydrogen, semi-autonomous, or autonomous vehicles, can provide a voice command interface that is accessible from an exterior of the vehicle. The voice command interface can include a plurality of microphones disposed on an exterior of a vehicle, through which enrolled or authorized users can initiate various vehicular functions without entering the vehicle or using a remote-control device for instance. The vehicular functions can include control of car locks, windows, heating, ventilation and air-conditioning (HVAC) features for instance, as well as semi-autonomous or autonomous driving operations such as self-parking, self-charging and passenger pick-up.

As vehicles and technology evolves, user experience with cars can get more and more seamless. To enter a vehicle and start the engine, the vehicle can sense a user's car key in proximity to the vehicle, so that the user does not even need to take the car key out of the user's pocket (or purse, bag and so on). Upon sensing the user's key in proximity, the vehicle can unlock its door in response to sensing the user's hands touching the vehicle's door handle for instance. And when the vehicle detects that the key is inside the car, the vehicle can start the engine when a start button of the vehicle is pressed. A car or other vehicle can be connected to the internet, and can be shared between drivers, a digital key (instead of a physical key or fob) can be stored in a user's mobile phone or other computing device. Such a mobile phone can be used in place of the key or fob to authenticate a user to use the car, while remaining in the user's pocket for instance. Such a hands-free operation can allow the use and sharing of the car to be more seamless, and can allow for a personalized user experience. Hands-free operation may not possible when the user wants to control certain features from outside of the car, for instance autonomous valet parking, or scheduling the vehicle to pick the user (e.g., car owner or a passenger) up at a given time and location, and so on. For such operations, a car key can be implemented to act as a remote control, or a mobile application can be installed on the user's device for use in controlling and initiating such features. However, such implementations nay not provide for a seamless user interaction that is hands-free, and can instead require user interactions that are complicated and prone to mistakes (e.g., due to visually complicated and crowded user interfaces to support various such operations).

To address the technical challenges apparent in such situations, the present systems and methods incorporate the use of a voice command interface for users located outside vehicles. To provide a user with a seamless, hands free mechanism to control a variety of vehicular functions or operations, a voice control interface can detect, authenticate and process voice commands from a user originating outside a vehicle, for instance without requiring the user to physically touch or operate a personal device, key or fob. Such a voice control interface can provide a more natural, unified, seamless and simple user experience, because the user can rely on and use the user's own voice or speech to flexibly control various vehicular functions, by minimizing or avoiding the use of any secondary or supplemental user interfaces (e.g., for touch or keypad based interactions) that can break the flow of the user's interaction with the vehicle.

A voice control interface as described herein can be more efficient than non-voice input because more precise instructions and a much greater range of instructions can be given by voice rather than the limited options that can be provided via interfaces on a key, fob or other device. For instance, when a user uses a wireless fob to communicate a complex command like “park yourself and pick me up in 20 minutes”, more back-and-forth interactions with the car may be needed (e.g., to press a sequence of buttons on the fob and to navigate across options menus). This consumes and wastes communications bandwidth, fob or other device battery power, and processing resources in an electric vehicle for example. The voice control interface, by providing a simple yet flexible interface, can consume less processing power and bandwidth.

The voice control interface, by providing a unified and simple user experience, can also improve user efficiency, for instance in operating the vehicle while outside the vehicle, thus saving the user's time and effort on the vehicle and enabling the user to apply more time and effort to other productive pursuits. The voice control interface, by providing a unified and simple user experience, can improve user effectiveness, for example by leveraging on the vehicle's various useful functions and capabilities, which otherwise would not be as easily or frequently accessed to assist the user (e.g., functions and capabilities that would otherwise require the user access via control and interfaces in the cabin of the vehicle). Thus, the voice or other audio or acoustic command interface can provide convenience (for a user located or remaining outside the vehicle) and encourage usage of the vehicle's useful functions thus increasing the vehicle's value to the user, and improving user satisfaction. The user's personal device, mobile application, key or fob can be rendered redundant or less important. Even when used as an alternative or supplementary source for authentication for instance, the user's personal device, mobile application, key or fob would not have to be designed to include a complicated or crowded user interface (e.g., in view of the availability of the vehicle's voice command interface), hence simplifying their design and reducing their cost of manufacture.

The voice control interface can include exterior microphones incorporated with the vehicle, and a speech module that uses speech recognition technology. The speech module can run a speech recognition algorithm that is always active or listening for incoming voice or other audio commands, to avoid having to have to use a press-to-talk button for instance. The speech module can send commands to various ECUs to control vehicle features, according to the incoming voice commands. The speech recognition algorithm can use one or more trained models as described herein, for instance. The speech recognition algorithm can perform analysis of speech signals (e.g., frequency tones, speech inflections and other structures and characteristics on various spoken words or phrases), The speech recognition algorithm can be used to recognize speech (e.g., the voice commands, which can include an activation phrase and an operational command) and can accept operational commands from rightful, authenticated users. The voice control interface can be used to enroll the user's voice and identity, and can pair the user's voice with the user's profile for instance (e.g., to improve matching of operational commands to the user's preferences and settings for the vehicle).

This enrollment can occur at the vehicle and can also involve the user's device (e.g., mobile phone, smart key or fob) to ensure that both systems can identify a rightful and authorized user of the vehicle. For instance, the user can initiate the enrollment process using the user's device (e.g., mobile phone, smart key or fob) or code registered with the vehicle, to activate the voice control interface. The user can input the user's voice via one or more of the exterior microphones, e.g., by providing speech renderings of various specified terms and phrases, which are recorded via the exterior microphone(s) into a memory storage unit of the vehicle. The user can concurrently input the user's voice via the user's device (e.g., to ensure consistency in recording and analyzing the user's voice, and to register between two sets of voice inputs recorded via the vehicle's voice control interface and via the user's device). At least some of the recordings can be maintained and used for comparisons with voice commands issued after the enrollment process. At least some of the recordings are used as datasets to train a model (e.g., neural network) to recognize and interpret voice commands. After enrollment, the user can issue voice commands via the voice command interface at the vehicle, or via the user's device (e.g., when the user is located away from the vehicle).

A user can use the voice control interface to control vehicle systems from outside of a vehicle with simple voice commands that can be accurately processed using the speech recognition technology, without requiring the user to use a key, fob, remote control, or smart phone for instance. The voice control interface can allow a user to conveniently control vehicular functions from outside the car, such as when the user has both hands busy, or is walking away from the vehicle. The voice control interface can allow a user to conveniently control vehicular functions from outside the car, without having to enter or re-enter the vehicle to access the vehicle's interior controls. Such vehicular functions can include opening and closing windows and sun roof, operate an electric lift-gate, trunk or front trunk (frunk) via voice command. The voice control interface can allow a user to control a vehicle's HVAC system to cool down or warm up the vehicle's cabin before the user enters the vehicle. As discussed above, an advantage of this system is that the user does not have to use an additional device like a phone or key fob, or have to enter the vehicle, to operate these functions of the vehicle when the user is outside and next to or near the car. Systems that require the use of such additional devices when the user is outside the car create unnecessary complicity and degrade the overall user experience by having to depart from a truly hands-free experience. Another solution uses a capacitive sensor to sense a foot hovering near it to open a trunk, but has the disadvantage of requiring the user to balance on one foot while trying to find the right sensor area for activation with the other foot, which can result in the user being prone to injury. The user's clothing (e.g., pants, skirt, socks, shoes) can get dirty in the process, or the sensor can be susceptible to temperature. For example, in situations like snow or extreme cold, the performance of the sensor can decrease to the point of having excessive false rejection rate. Even in general, the false rejection rate of such capacitive sensor systems is high.

The voice command interface can incorporate or use biometric identification to ensure security, and can make the experience more individualized for each user. For example, by applying individualized or customized voice processing for a user, the voice command interface can reduce false acceptance rates and false positive rates, by applying the user's preferences, referencing the user's history of voice commands, comparing against the user's enrolled voice or speech features, or using a model trained specifically for the user. Further, the user can use a mobile application or a device (e.g., a smartphone) to receive voice commands from the user and connect remotely to the vehicle when the vehicle is too far away to detect and receive voice commands directly from the user. For instance, the user can use the mobile application or device to summon the vehicle that is parked or otherwise located far away from the user. The voice command interface can be extended such that the user can provide voice commands to a mobile application or device in a similar fashion as providing voice commands directly to a vehicle, hence ensuring familiarity and improving user friendliness.

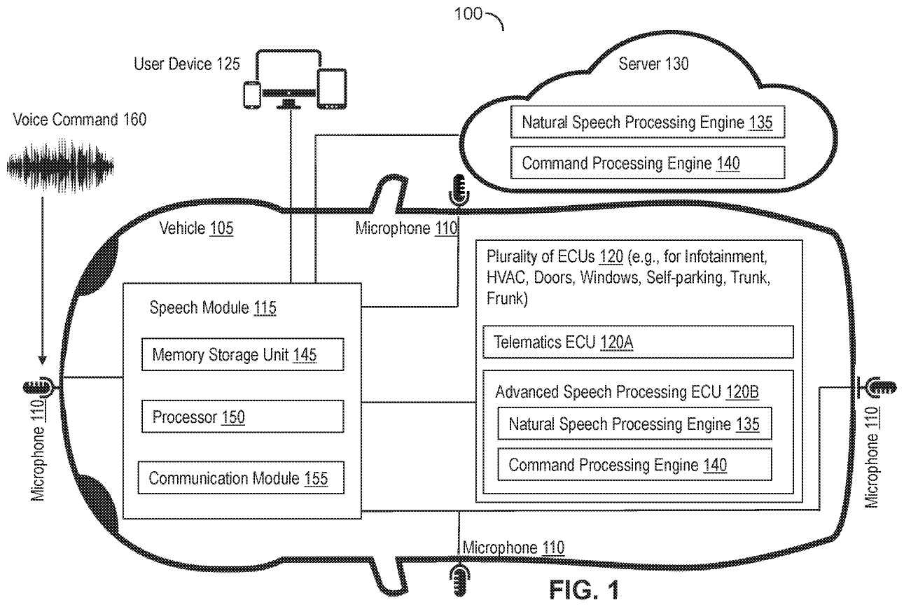

FIG. 1, among others, depicts a block diagram of an example system 100 to control vehicular functions using voice commands that originate outside vehicles. The system 100 can include at least one vehicle 105 that can include a plurality of microphones 110, at least one speech module 115, and a plurality of ECUs 120. The plurality of ECUs can include a telematics ECU 120A, and an advanced speech processing ECU 120B for instance. The vehicle can communicate with one or more user devices 125 and one or more servers 130. A user device can include any personal, user or computing device, such as a smart key, fob or remote control with communications electronics, a smart phone, a tablet, a laptop and so on. The vehicle 105 may include, for example, an automobile (e.g., a passenger sedan, a truck, a bus, electric vehicle, fossil fuel vehicle, hybrid-electric vehicle, van, or a vehicle with partial or full autonomous capabilities), a motorcycle, an aircraft, a locomotive, hovercraft, or a watercraft, among other vehicles. The vehicle 105 can include any electric vehicle (EV), hybrid EV (HEV) or non-electric vehicle, of any form or type, such as a car, motorcycle, scooter, passenger vehicle, passenger or commercial truck, or other vehicle such as a sea or air transport vehicle, plane, helicopter, submarine, boat, or drone. The vehicle 105 can be fully autonomous, partially autonomous, manually operated, or unmanned.

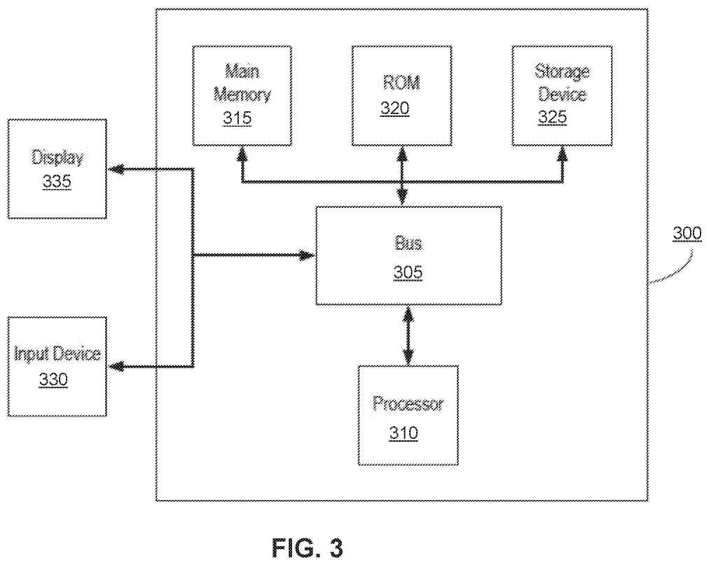

The elements or components in system 100 can be implemented in hardware, or a combination of hardware and software, in one or more embodiments. Each component of the system 100 may be implemented using hardware or a combination of hardware or software detailed in connection with FIG. 3. For instance, each of these elements or components, such as the speech module 115, communication module 155, ECUs 120, natural speech processing engine 135, command processing engine 140, or other components can include any application, program, library, script, task, service, process or any type and form of executable instructions executing on hardware of the vehicle 105 or server 130 such as processors, logic circuits, or memory storage devices. The hardware can include circuitry such as one or more processors.

The vehicle 105 can include at least one microphone 110. Each microphone 110 can be disposed, mounted, installed and built at least partially on an exterior of the vehicle 105. The microphone 110 can be incorporated as part of an exterior surface or component of the vehicle 105. A portion of the microphone 110 can be exposed to an exterior of the vehicle 105 and can receive as input acoustic signals including voice or speech that originates from outside the vehicle 105. The microphone 110 can detect, sense, access or otherwise receive voice commands originating from outside the vehicle 105. The microphone 110 can designed to receive audio signals within typical human speech or voice frequency ranges, such as 85 to 255 Hz (or 75-280 Hz, or other range). The microphone 110 can include filter(s), amplifier(s) and noise-cancelling features, to extract process and enhance received voice commands 160. The microphone 110 can receive a voice command 160 as audio signal(s), and can convert the audio signal(s) into electrical signal(s). The microphone 110 can be powered by at least one battery of the vehicle 105.

A plurality of the microphones 110 can be spatially disposed at various portions or locations of the vehicle 105, e.g., to maximize reception capability and effectiveness for receiving voice commands originating from various locations and directions outside the vehicle 105. For instance, a number of microphones 110 can be dispersed and located at the front, rear and two sides (e.g., proximate to doors) of the vehicle 105, as illustrated in FIG. 1. Some of the microphones 110 can be directional (e.g., tuned or implemented with a defined spatial cone or angular range of reception) for example. One or more microphones 110 can be located on a roof or top portion of the vehicle 105, and can perform omnidirectional audio reception for instance.

The vehicle 105 can include a speech module 115. The speech module 115 can be designed or implemented to process electrical signal(s) from one or more of the microphones 110 corresponding to a voice command 160. The speech module 115 can be communicatively coupled to the plurality of microphones 110, to receive the electrical signal(s). The speech module 115 can receive electrical signal(s) corresponding to audio signal(s) of a voice command 160 received by at least one of the plurality of microphones 110. The speech module 115 and the microphones 110 can maintain, buffer, cache, hold or otherwise store the electrical signal(s) of a voice command 160 in at least one memory storage unit 145 of the speech module 115. The memory storage unit 145 can store (e.g., temporarily store) the electrical signal(s) so that the electrical signal(s) can be processed. The memory storage unit 145 can include one or more features of the main memory 315 and storage device 325 discussed in connection with FIG. 3. The memory storage unit 145 can reside in the speech module 115 as part of the speech module 115. The memory storage unit 145 can reside at another location in the vehicle 105 (e.g., in one of the ECUs 120). The speech module 115 can be disposed or reside in its entirety or in part within the vehicle 105. For example the speech module 115 can be part of an onboard data processing system of the vehicle. All or part of the speech module can reside remotely from the vehicle, for example within the user device 125 or the server 130.

The speech module 115 can include or correspond to at least one ECU 120 of the vehicle 105. The speech module 115 can operate in a low power mode (e.g., consuming less than 20%, or some other value, of the power consumed at active mode). The speech module 115 (or some of its components) can be activated when a microphone 110 detects an audio input (e.g., voice command 160). The microphone can store the electrical signal(s) generated from the audio input in a memory storage unit 145 (e.g., of the speech module 115), while activating the speech module 115 from low power (or power saving) mode to process the electrical signal(s).

Some or all of the electrical signal(s) can be processed by one or more processors 150 of the speech module 115. Each of the processors 150 can include one or more features of the processor 310 discussed in connection with FIG. 3. Some or all of the electrical signal(s) can be communicated via at least one communication module 155 of the speech module 115, to one or more servers 130 for processing. The communication module 155 of the speech module 115 can communicate some or all of the electrical signal(s) to one or more ECUs 120 for processing. For instance, the speech module 115 can communicate the electrical signal(s) to an advanced speech processing ECU 120B of the vehicle 105 for processing. The processing as discussed herein can be performed in real-time or near real-time (e.g., within a latency of 200 milliseconds, 400 milliseconds, or other value) relative to the reception of the corresponding voice command 160.

The voice command 160 can be referenced herein as the content (in any form) of the corresponding received audio signals. Hence, a microphone 110 can receive the voice command 160 (e.g., in audio form) and send the voice command 160 (e.g., in electrical form) for storage in the memory storage unit 145. Also, the voice command 160 (e.g., in electrical form) can be processed by a processor 150 of the speech module 115 for instance. The speech module 115 can send the voice command 160 (e.g., in electrical form) to the server(s) 130 or to the advanced speech processing ECU 120B of the vehicle 105 for processing.

The voice command 160 can include one or more components. For example, the voice command 160 can include an activation phrase, which can be followed by an operational command. The activation phrase can be a predefined or standard phrase for indicating to the speech module 115 to expect an operational command to follow the activation phrase (e.g., within the voice command 160). The activation phrase can be any phrase chosen, specified or selected by a user or owner of the car during an enrollment or registration phase in preparation to use voice commands 160. The activation phrase can for instance correspond to any of the example phrases: “OK car”, “Hey car”, “Car command”, “Voice control” and so on.

The activation phrase can be an indicator to the speech module 115 to record and store a portion of the voice command 160 (e.g., the operational command) in the memory storage unit 145. The activation phrase can be an indicator to the speech module 115 to process a portion of the voice command 160 (e.g., the operational command). The activation phrase can be an indicator to the speech module 115 to biometrically verify or otherwise authenticate the person that issued the voice command, using a portion of the voice command 160 (e.g., the activation phrase). The activation phrase can be an indicator to the speech module 115 to activate (e.g., wake up, or initiate certain functionality from a low power mode for instance) of the speech module 115 (e.g., communication module 115). The activation phrase can be an indicator to the speech module 115 to activate (e.g., wake up, or initiate certain functionality) of an ECU 120 (e.g., a command processing engine 140 of the advanced speech processing ECU 120B).

The operational command of the voice command 160 can include one or more instructions for the vehicle 105 to initiate, perform and complete one or more vehicular functions. The operational command can temporally occur after or following the activation phrase (e.g., after a pause of 200 milliseconds to 2 seconds in duration, or some other range). The operational command can include a string or sequence of commands for multiple vehicular functions. The commands can be performed concurrently, and can be independent of each other. The commands can be performed according to a sequence. The operational command can include natural language constructs (e.g., “please leave a slight opening in the front passenger side window”), to undergo natural language processing at least one natural speech processing engine 135 for instance. The operational command can include predefined terms and language constructs, such as <object/feature> <action/value> (e.g., “window close”, “AC on”, “AC seventy degrees”). By way of some non-limiting examples, operational commands can include:
turn on air conditioning to cool down cabin to 60 degrees, and let me know
open the trunk/frunk
close the sunroof
close the sunroof if it rains
turn on headlights
report battery charge level
unlock rear passenger-side door
park the car at parking garage No. 6
find a shade to park under
find a legal parking spot and park there
park yourself and send me your location when parked
charge the vehicle's batteries
return to pick me up at 6 pm
drive around the block and pick me up in 5 mins
drive to junior's school to pick him up and send him to grandma's
get a carwash and return here
get a routine service at the car dealership
open the rear hatch and lower the seat back
pick up my briefcase from Stacy at home (message/call Stacy for the briefcase when you reach home)
set the car to my programmed settings (e.g., for seats, mirrors, temperature, radio station, before I enter the car)
wait for me at the end of the street with hazard lights on
activate an alarm
initiate a call to a phone number or entity
move two feet forward from this spot
follow at a distance behind me as I walk

The processor(s) 150 of the speech module 115 can receive or access the voice command 160 (e.g., from the microphone 110, or recorded into the memory storage unit 145), and to recognize the activation phrase and the operational command from the voice command 160. The processor 150 can determine if the activation phrase is present and valid within a received candidate voice command. The processor 150 can determine if the operational command is present and valid within a received candidate voice command. For instance, a processor 150 can compare or match one or more portions (e.g., a front or first portion, corresponding to the activation phrase) of the voice command 160 with one or more enrolled phrases or recordings of one or more users. The comparison can include a biometric comparison using speech or vocal features (e.g., pronunciation, voice inflection, tone) present in the voice command 160 (e.g., in the activation phrase portion). The processor 150 can process the one or more portions using a model (e.g., that is trained using one or more enrolled phrases or recordings of one or more users), to recognize a valid activation phrase, operational command, or both, in the voice command 160. The processor 150 can perform language and content recognition on the voice command 160, for the activation phrase, the operational command, or both.

The processor 150 may not be able to perform some of the processing (e.g., comparison, matching, biometric comparison, recognition) of the voice command 160. The speech module 115 can use, instruct, request or interoperate with the advanced speech processing ECU 120B, or the server(s) 130, to perform the processing. The processor 150 can send or forward the operational command portion of the voice command 160 to at least one command processing engine 140 of the advanced speech processing ECU 120B, or the server(s) 130, for processing. For example, if the processor 150 determines that the operational command portion of the voice command 160 includes natural language features, the communication module 155 can forward the operational command to the natural speech processing engine 135 of the advanced speech processing ECU 120B, or the server(s) 130, for natural language processing to recognize and understand the user's desired command or instructions.

At least a portion of the speech module 115 (e.g., processor 150) can operate in an active mode while some other portion (e.g., a communication module 155) of the speech module 115 can operate in a low-power or inactive mode. For example, the processor 150 can determine if an activation phrase is present, valid or authenticated (e.g., biometrically matched to a person authorized to control the vehicle 105), and can activate the communication module 155 if the activation phrase is present, valid or authenticated. The communication module 155 can be activated to communicate the operational command to a command processing engine 140 of the advanced speech processing ECU 120B, or of the server(s) 130, for processing. For instance, the communication module 155 can be caused to exit a low power mode and enter into an active mode to wirelessly transmit the operational command to a command processing engine 140 of a server 130.

The server(s) 130 can process at least a portion of the voice command 160. The server(s) 130 can be part of a cloud or a network of servers communicatively connected (e.g., wirelessly) with the communication module 155 through one or more networks. The server(s) can provide one or more services to the vehicle 105 or the user of the vehicle, for example voice authentication services (e.g., to perform biometric matching on the activation phrase), operational command services (e.g., to interpret and translate an operational command into instructions that ECUs 120 of the vehicle 105 can understand), and natural language processing services (e.g., to apply artificial intelligence processing using trained models to understand or interpret an operational command).

The natural speech processing engine 135 can perform natural language processing on at least a portion of the voice command 160 (e.g., the operational command), to understand and interpret the operational command (e.g., dissect and synthesize the operational command to determine if the operational command includes multiple commands, and if there should be a sequence for performing the command). The natural speech processing engine 135 can use one or more models (e.g., neural networks) developed through training using one or more datasets associated with one or more users (e.g., using voice commands recorded during an enrollment process via the microphone(s) and the speech module 115 for instance). The natural speech processing engine 135 can apply at least a portion of a voice command 160 as input through a model, and obtain an output with an interpretation (and a corresponding probability of correctness of the interpretation for instance) of the input. The natural speech processing engine 135 can provide an output or an interpretation of the operational command for instance, to the speech module 115, or to the command processing engine 140 for further processing. For example, the speech module 115 can translate the interpretation into instructions that ECUs 120 of the vehicle 105 can understand.

The command processing engine 140 can receive an input (e.g., operational command, or an interpretation thereof) from the communication module 155, or from the natural speech processing engine 135. The command processing engine 140 can interpret and translate the input into instructions, e.g., that ECUs 120 of the vehicle 105 can understand. The command processing engine 140 can interpret and translate the input into instructions that the speech module 115 can understand, and the speech module 115 can further translate these instructions into instructions that the ECUs 120 of the vehicle 105 can understand. Functionalities of the natural speech processing engine 135 and the command processing engine 140 can be integrated or combined. For example, the natural speech processing engine 135 can include or incorporate the command processing engine 140. In some implementations, the command processing engine 140 can include or incorporate the natural speech processing engine 135.

One or more ECUs of the vehicle 105 can perform, or provide instructions that operate vehicle hardware to perform, different vehicular functions. One or more ECUs can receive instruction(s) from the communication module 155 of the speech module 115 to perform one or more vehicular functions. The vehicle 105 can include a plurality of ECUs 120 networked together for communicating and interfacing with one another. The ECUs 120 can be communicatively coupled with one another via wired connection (e.g., vehicle bus) or via a wireless connection (e.g., near-field communication).

An ECU 120 can be or include an embedded system in the vehicle 105 that controls one or more of the electrical system or subsystems in a vehicle 105. An ECU 120 can be referred to herein as an automotive computer, and can include a processor or microcontroller, memory, embedded software, inputs, outputs and communication link(s). An ECU can use vehicle 105 hardware and software to perform the vehicular functions expected from that particular module. For example, types of ECU include Electronic/engine Control Module (ECM), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), control unit, or control module. Other examples include domain control unit (DCU), Electric Power Steering Control Unit (PSCU), Human-machine interface (HMI), Telematics control unit (TCU) (sometimes referred as a telematics ECU), Speed control unit (SCU), Battery management system (BMS), and so on.

ECUs can be used in multiple settings related to a vehicle 105 and can operate in different domains. For example, in advanced drive-assistance systems (ADAS), there can be over a hundred ECUs communicating with one another through a vehicle network. In addition, various environment sensors and other sensing components (e.g., global position system (GPS), inertial measurement unit (IMU), camera, Radar, LiDAR, ultrasonic sensor, and vehicle-to-everything (V2X) wireless sensors) can each be connected to a different, dedicated ECU for data acquisition, process, or vehicle control purposes. Other applications or vehicular functions in which ECUs are used can include passenger comfort systems, security systems, chassis, body, powertrain and battery management systems, among others. For example, the ECUs 120 can include ECUs for vehicular functions involving infotainment, HVAC, doors, windows, self-parking, trunk, frunk, sunroof, rear hatch, folding seats, self-driving, communications, self-charging, weather detection, and so on.

The communication module 155 can communicate with the ECUs 120 using one or more communication protocol standards, such as Controller Area Network (CAN), CAN with Flexible Data-Rate (CAN FD), Local Interconnect Network (LIN), FlexRay, Media Oriented Systems Transport (MOST), Ethernet, Serial Peripheral Interface (SPI), Peripheral Sensor Interface (PSI5), Distributed Systems Interface (DSI), and Single Edge Nibble Transmission (SENT), among others.

The ECUs 120 can include one or more advanced speech processing ECUs 120B. An advanced speech processing ECU 120B can include at least one of a natural speech processing engine 135 and a command processing engine 140. These components can include features and functionalities that are the same as or similar to those of the natural speech processing engine 135 and the command processing engine 140 of the server(s) 130. Accordingly, the speech module 115 can request or instruct the advanced speech processing ECU 120B to process at least a portion of a voice command 160. For example, the speech module 115 can receive output from the advanced speech processing ECU 120B that includes instructions (e.g., corresponding to the operational command) that the ECUs 120 of the vehicle 105 can understand. Hence, the communication module 155 can send, manage, coordinate and distribute the instructions to one or more ECUs 120 for execution, to perform the corresponding vehicular function(s).

The ECUs 120 can include one or more telematics ECUs 120A. The one or more telematics ECUs 120A can include an embedded system of one or more devices (sometimes referred as telematics control units) that control tracking of the vehicle 105, and can include at least one of a GPS unit, and external interface for mobile communication which provides the tracked values to a centralized geographical information system (GIS) database server, an electronic processing unit, a microcontroller, a mobile communication unit, and memory (e.g., for storing GPS values or vehicle sensor data), for example.

For certain vehicular functions corresponding to certain operational commands, the vehicle 105 may communicate with a user device 125. For instance, the vehicle 105 can inform a user that the vehicle 105 has completed a vehicular function (or task) corresponding to the user's operational command. The vehicle 105 can inform the user by sending a message via the communications module 155 or via the mobile communications unit of the telematics ECU 120A. For instance, the speech module 115 can send an instruction to the telematics ECU 120A to send a text message to the user's user device 125 (e.g., to indicate that the vehicle 105 has completed self-parking, and to indicate the location of the vehicle 105). The telematics ECU 120A can use its GPS unit and external interface for mobile communication to determine the location of the vehicle 105 for example. The vehicle 105 can call or message a person, via the communications module 155 or via the mobile communications unit of the telematics ECU 120A, to perform a pick-up for an item or person when the vehicle is arriving or has arrived at the location of the pick-up. The vehicle 105 can communicate, via the communications module 155 or via the mobile communications unit of the telematics ECU 120A, with a user's device 125 to find out a location of the user, e.g., in order to drive to the user's location, and to estimate a driving time to arrive at the user's location.

For certain vehicular functions corresponding to certain operational commands, the vehicle 105 may communicate with some other type of device or a system, such as an electric charging station, a garage door controller, a parking payment system, a toll payment system, an automatic carwash station, and so on. The vehicle 105 can communicate with such a device or system by communicating via the communications module 155 or via the mobile communications unit of the telematics ECU 120A. For instance, the speech module 115 can send an instruction to the telematics ECU 120A to provide payment information to a parking payment system, and to receive an electronic receipt or confirmation from the parking payment system for a completed payment transaction.

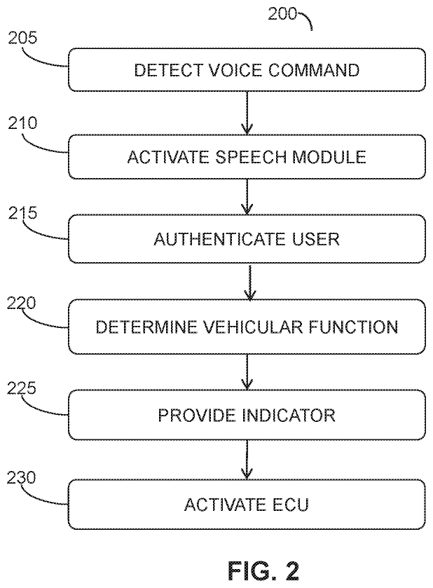

FIG. 2, among others, depicts a flow diagram of an example method 200 to control vehicular functions using voice commands that originate outside vehicles. The operations of the method 200 can be implemented or performed by various components of the vehicle 105 and server 130 as detailed herein above in conjunction with FIG. 1 or the computing system 300 as described below in conjunction with FIG. 3, or any combination thereof. For example, the functionalities of the method 200 can be performed on the vehicle 105, distributed among the one or more ECUs 120 as detailed herein in conjunction with FIG. 1. The method can include detecting a voice command (ACT 205). The method can include activating a speech module (ACT 210). The method can include authenticating a user (ACT 215). The method can include determining a vehicular function (ACT 220). The method can include providing an indicator (ACT 225). The method can include activating an ECU (ACT 230).

At least one of a plurality of microphones 110 can detect a voice command (ACT 205). The plurality of microphones 110 can be disposed on an exterior of a vehicle 105. The plurality of microphones 110 can be actively listening to or detecting audio signals in the vicinity of the vehicle 105. The plurality of microphones 110 can be activated when persons exit the vehicle 105. The plurality of microphones 110 can be activated when the vehicle 105 is stationary, e.g., when unoccupied by or devoid of occupants. The plurality of microphones 110 can be activated in response to a motion detector of the vehicle 105 detecting a person or movement nearby (e.g., within a range of the vehicle 105, such as 5 meters, or other value).

The at least one of the plurality of microphones 110 can detect a voice command from a user located outside the vehicle 105. The voice command can include an activation phrase followed by an operational command. The plurality of microphones 110 can monitor for, detect and receive audio signals (e.g., corresponding to the voice command 160) within typical human speech or voice frequency ranges, such as 85 to 255 Hz (or 75-280 Hz, or other range). For instance, a microphone 110 can receive the voice command 160 as audio signal(s), and can convert the audio signal(s) into electrical signal(s). The microphone 110 can use filter(s), amplifier(s) and noise-cancelling features, to extract, process and enhance the received voice commands 160 in the electrical signal(s). The microphone 110 can record, maintain, buffer or store the voice command (e.g., the electrical signals) in a memory storage unit of the vehicle 105 (e.g., of a speech module) temporarily for instance. The microphone 110 can store or hold the voice command in the memory storage unit, for instance while a speech module is activated to process the voice command. The memory storage unit 145 can store (e.g., temporarily store) the electrical signal(s) corresponding to the voice command 160 so that the electrical signal(s) can be processed by a speech module of the vehicle 105. The microphone 110 can store the electrical signal(s) generated from the audio signals in the memory storage unit 145, while activating the speech module 115 from inactive, low power, or power saving mode to process the electrical signal(s).

The at least one of the plurality of microphones 110 can activate a speech module 115 (ACT 210). The at least one of the plurality of microphones 110 can activate, responsive to the detection or reception, the speech module 115 of the vehicle 105. The speech module 115 (or some of its components) can be activated when a microphone 110 detects an audio input (e.g., voice command 160). The speech module 115 can for example be activated from a low-power or inactive mode of the speech module. The vehicle 105 can at least one of activate the speech module of the vehicle 105 (via the microphone(s) 110), authenticate the user (via the speech module 115), and activate the first ECU 120 (via the speech module), without involving a key, fob, or device of the user. In some implementations, the vehicle 105 can perform one or more of these operations upon detecting a presence of a key, fob, or device of the user near the vehicle 105 (e.g., within a range of the vehicle 105, such as 5 meters, or other value).

The speech module 115 can, upon activation from the low power or inactive mode, access the recorded voice command 160 from the memory storage unit 145. The speech module 115 can, upon activation from the low power or inactive mode, process the voice command 160. The speech module 115 can process electrical signal(s) from one or more of the microphones 110 corresponding to the voice command 160. The speech module 115 can process electrical signal(s) accessed from the memory storage unit 145. Some or all of the electrical signal(s) can be processed by one or more processors 150 of the speech module 115. The speech module 115 can access, upon activation from the low power mode, the recorded voice command 160 from the memory storage unit 145 to authenticate a user (e.g., a person attempting to use a voice command 160 to operate the vehicle 105).

The speech module 115 can authenticate a user (ACT 215). The speech module 115 can authenticate the user according to the activation phrase of the voice command 160. The speech module 115 can parse the recorded voice command 160 for the activation phrase to authenticate the user. The speech module 115 can match a portion of the voice command 160 with a defined phrase (e.g., preprogrammed in the speech module 115, or selected and recorded by the user through the speech module 115 and microphone(s) 110). The portion of the voice command 160 being matched can correspond to an activation phrase (e.g., configured to precede an operational command, and to trigger processing of the operational command). The speech module 115 can identify and extract the portion of the voice command 160 that matched the defined phrase. The speech module 115 can identify that the portion of the voice command 160 that matched the defined phrase is an activation phrase. The speech module 115 can determine that the activation phrase is present and valid responsive to the matching. For instance, a processor 150 of the speech module 115 can determine if the activation phrase is present and valid within a received candidate voice command 160. The processor 150 can compare or match one or more portions (e.g., a front or first portion, corresponding to the activation phrase) of the voice command 160 with one or more enrolled phrases or recordings of one or more users. The processor 150 can perform language and content recognition on the voice command 160, for the activation phrase, the operational command, or both.

The matching can include biometric matching against an enrolled recording. The comparison can include a biometric comparison using speech or vocal features (e.g., pronunciation, voice inflection, tone) present in the voice command 160 (e.g., in the activation phrase portion). The speech module 115 can biometrically verify or otherwise authenticate the person that issued the voice command 160, using a portion of the voice command 160 (e.g., the activation phrase). The speech module 115 can biometrically match the portion of the voice command 160 (e.g., activation phrase) with an enrolled recording of the user. The speech module 115 can authenticate the user by biometrically matching the portion of the voice command 160 with the enrolled recording.

Responsive to authenticating the user, the speech module 115 can parse the recorded voice command 160 for the operational command (e.g., to determine a vehicular function corresponding to the operational command). The speech module 115 can parse, extract, isolate and identify the operational command as a portion of the voice command 160 following the activation phrase. Responsive to authenticating the user, and responsive to identifying the activation phrase, the speech module 115 can parse, extract, isolate, identify and recognize the operational command from the voice command 160. Any of the operations or acts of the speech module 115 as described herein can be performed by at least one processor of the speech module 115. For instance, a processor 150 of the speech module 115 can determine if the operational command is present and valid within a received candidate voice command 160.

The speech module 115 can interpret, translate or otherwise process the portion of the voice command 160 corresponding to the operational command. The speech module 115 can process any portion of the voice command 160 using a model (e.g., trained model). A model can be trained using datasets comprising recordings of audio signals that includes at least one voice command 160. For example, at least one of the plurality of microphones can record a plurality of voice commands from the user, and can store the recording(s) in the memory storage unit. The speech module 115 can use the plurality of voice commands to train a model to at least one of: recognize the activation phrase from the plurality of voice commands, recognize the user according to the activation phrase from the plurality of voice commands, and determine operational commands from the plurality of voice commands. The speech module 115 can use the trained model to at least one of: recognize the activation phrase from the voice command 160, recognize the user according to the activation phrase (e.g., authenticate the user), and determine the operational command from the voice command 160.

The speech module 115 can use the trained model to determine, parse, extract, isolate, identify and recognize the operational command from the voice command 160. The speech module 115 can (e.g., use the trained model to) interpret, translate, recognize and understand predefined terms and language constructs of the operational command, to determine an associated vehicular function. The speech module 115 can detect for the presence of certain constructs in the operational command, e.g., natural language constructs (e.g., using the trained model). Responsive to the detection, the speech module 115 can activate a natural speech processing engine 135 for instance, which can correspond to a processor of the speech module 115, or can reside on one or more servers 130, or in an advanced speech processing ECU 120B for example. The speech module 115 may not be equipped or configured to perform processing of operational commands or certain types of operational commands (e.g., those to involve natural language processing). The speech module 115 can use, instruct, request or interoperate with the advanced speech processing ECU 120B, or the server(s) 130, to perform the processing. A processor 150 of the speech module 115 can send or forward the operational command portion of the voice command 160 to a command processing engine 140 of the advanced speech processing ECU 120B, or the server(s) 130, for processing.

The speech module 115 can send or forward the operational command portion of the voice command 160 to a natural speech processing engine 135 of the advanced speech processing ECU 120B, or the server(s) 130, for processing. For example, if the processor 150 determines that the operational command portion of the voice command 160 includes natural language features, the communication module 155 can forward the operational command to the natural speech processing engine 135 of the advanced speech processing ECU 120B, or the server(s) 130, for natural language processing to recognize and understand the user's desired command or instructions. The speech module 115 can activate the natural speech processing engine 135 (e.g., from inactive or low power module), to perform the processing. By activating the natural speech processing engine 135 (and advanced speech processing ECU 120B for instance) only when needed, this can allow energy conservation in the batteries of the vehicle 105, and can prolong the time in between battery re-charging. The speech module 115 can request or instruct the natural speech processing engine 135 to interpret, translate or otherwise process the operational command from the voice command 160, to determine an associated vehicular function.

The natural speech processing engine 135 can perform natural language processing on at least a portion of the voice command 160 (e.g., the operational command), to understand and interpret the operational command (e.g., dissect and synthesize the operational command to determine if there are multiple parts of the command, and if there should be a sequence for performing the command). The natural speech processing engine 135 can use one or more models (e.g., neural networks) developed through training using one or more datasets associated with one or more users (e.g., using voice commands recorded during an enrollment process via the microphone(s) and the speech module 115 for instance). The natural speech processing engine 135 can apply at least a portion of a voice command 160 as input through a model, and obtain an output with an interpretation (and a corresponding probability of correctness of the interpretation for instance) of the input. The natural speech processing engine 135 can provide an output or an interpretation of the operational command for instance, to the speech module 115, or to the command processing engine 140 for further processing. For example, the speech module 115 can translate the interpretation into instructions that ECUs 120 of the vehicle 105 can understand.

The command processing engine 140 can receive an input (e.g., operational command, or an interpretation thereof) from the communication module 155, or from the natural speech processing engine 135. The command processing engine 140 can interpret and translate the input into instructions, e.g., that ECUs 120 of the vehicle 105 can understand. The command processing engine 140 can interpret and translate the input into instructions that the speech module 115 can understand, and the speech module 115 can further translate these instructions into instructions that the ECUs 120 of the vehicle 105 can understand. Functionalities of the natural speech processing engine 135 and the command processing engine 140 can be integrated or combined. For example, the natural speech processing engine 135 can include or incorporate the command processing engine 140. In some implementations, the command processing engine 140 can include or incorporate the natural speech processing engine 135.

The speech module 115 can determine a vehicular function (ACT 220). The speech module 115 can determine a vehicular function corresponding to the operational command of the voice command 160. The speech module 115 can determine the vehicular function by using the processor(s) 150 to process the operational command. The speech module 115 can determine the vehicular function by the processing of the operational command at the server(s) 130 or the advanced speech processing ECU 120B. For example, the speech module 115 can determine the vehicular function corresponding to the operational command of the voice command 160, by activating a natural speech processing engine from a low power mode of the natural speech processing engine, and determining, via the natural speech processing engine, the vehicular function corresponding to the operational command of the voice command 160. The speech module 115 can determine the vehicular function corresponding to the operational command of the voice command 160, by communicating the operational command of the voice command 160 to command processing engine executing on a server, and determining, via communication with the command processing engine, the vehicular function corresponding to the operational command of the voice command 160.

The speech module 115 can provide an indicator (ACT 225). The speech module 115 can provide an indicator to the user that provided the voice command 160, to acknowledge the voice command 160. The speech module 115 can provide an indicator to acknowledge the operational command or voice command 160, responsive to detecting the activation phrase and validating the activation phrase. The speech module 115 can provide an indicator to acknowledge the operational command or voice command 160, responsive to authenticating the user. The speech module 115 can provide the indicator to the user prior to executing the operational command (e.g., to initiate and perform a corresponding vehicular function).

The indicator to acknowledge the operational command can include at least one of an audio indicator and a visual indicator. For example, the vehicle 105 can include a speaker or audio output device (e.g., a horn) to provide the audio indicator. The audio indicator can include recorded or synthesized speech or sounds (e.g., of any pattern, level or duration), and can include audio content of any form (e.g., beep, toot, buzz, chime). For instance, the audio indicator can include a voice that acknowledges and announces or repeats the operational command (or the vehicle's interpretation of the operation command) to the user. By way of example, the audio indicator can include the phrase: “OK, performing <operational command>, or “Got it, initiating <corresponding vehicular function>.”

The visual indicator can include a signal or illumination (e.g., of any pattern, level, color or duration) from one or more light indicators, headlights, tail lights and in-cabin lights of the vehicle 105. The visual indicator can include graphics and animation, and can be on a display on the vehicle 105 (e.g., a built-in exterior display screen), or include a projection (e.g., on a window or windscreen, or on the ground). The visual indicator can include text that announces or repeats the operational command (or the vehicle's interpretation of the operation command) to the user. By way of example, the visual indicator can include the phrase: “OK, performing <operational command>, or “Got it, initiating <corresponding vehicular function>.”

The speech module 115 can cause the vehicle 105 (e.g., an ECU 120 of the vehicle 105) to provide an indicator (visual, audio, or both) to the user to acknowledge the operational command. In an illustrative scenario, the speech module 115 can detect, subsequent to the indicator, another voice command 160 comprising another operational command, to cancel the operational command acknowledged by the indicator. The speech module 115 can receive the another voice command 160 via the microphone(s) 110, prior to completion of the processing a vehicular operation corresponding to the operational command acknowledged by the indicator. For example, a first ECU 120 can be activated and instructed by the speech module 115 to perform a vehicular function corresponding to the operational command acknowledged by the indicator. The user can issue the second voice command 160 to cancel, null, replace and supersede the operational command acknowledged by the indicator. Responsive to receiving the another/second voice command 160 (e.g., validating an activation phrase and identifying a new operational command), the speech module 115 can instruct the first ECU 120 to cancel (e.g., halt, terminate, and not perform) the vehicular function corresponding to the operational command acknowledged by the indicator. Responsive to receiving the another/second voice command 160, the speech module 115 can activate and instruct another ECU 120 to perform a vehicular function corresponding to the operational command in the another/second voice command 160.

The speech module 115 can activate an ECU 120 (ACT 230). The speech module 115 can activate a first ECU 120 (of a plurality of ECUs of the vehicle 105) that corresponds to the vehicular function, from a low power or inactive mode of the first ECU 120 to perform the vehicular function. The speech module 115 can activate, responsive to authenticating the user, the first ECU 120. The speech module 115 can activate or initiate, responsive to recognizing and identifying the operational command, the first ECU 120 to perform a vehicular function corresponding to the operational command. For example, the processing of the operational command (e.g., by the advanced speech processing ECU 120B) can produce an output comprising information, commands and instructions identifying a vehicular function and a ECU 120 (or type of ECU) for performing the corresponding vehicular function.

Responsive to receiving this output, the speech module 115 can select a first ECU 120 identified by the output. The speech module 115 can select a first ECU 120 according to the vehicular function. The speech module 115 can activate the first ECU 120, e.g., from inactive or low power mode. By allowing such ECUs to remain in inactive or low power mode until a corresponding operational command is identified and ready to be executed, the present systems and methods can allow energy conservation in the batteries of the vehicle 105, and can prolong the time in between battery recharging. The speech module 115 can send an instruction to the first ECU 120 to perform the vehicular function (e.g., using the command and instructions of the output). The first ECU 120 can perform the vehicular function responsive to the instruction.

The first ECU 120 can provide or cause the vehicle 105 (e.g., a telematics ECU 120 A of the vehicle 105) to provide a notification to the user responsive to completion of the determined vehicular function. The notification can include an electronic transmission (e.g., text message, email, mobile application messaging) to a device of the user (e.g., a cellphone, a smart key fob) when the user is beyond a vicinity of the vehicle 105 (e.g., beyond a range such that an audio or visual indicator at the vehicle 105 might not be detected by the user, such a 20 meters or some other distance or range). The notification can include an at least one of an audio and a visual indicator from the vehicle 105 when the user is in a vicinity of the vehicle 105 (e.g., within a range such that the audio or visual indicator at the vehicle 105 can be detected by the user, such a 20 meters or some other distance or range). The audio indicator and the visual indicator can for example include any embodiment described herein in connection with the indicator to acknowledge an operational command.

The microphone(s) can detect an absence of voice commands over a defined time period. The speech module 115 can determine that there is an absence of voice commands over a defined time period, e.g., by detecting an absence of a valid and authenticated activation phrase. The speech module 115 can, responsive to the absence of detected voice commands over a defined time period, at least one of: enable the speech module 115 to enter the low power mode of the speech module 115, and instruct one or more ECUs (e.g., the first ECU 120) to enter a low power or inactive mode.

In an illustrative scenario, a first ECU 120 (e.g., instructed to perform a vehicular function by the speech module 115) can determine that the first ECU 120 cannot perform the vehicular function. For example, the first ECU 120 can determine that there are no legal or viable parking spots (e.g., within a specified driving range) to self-park, and can indicate to the speech module 115 that the first ECU 120 cannot perform the vehicular function (e.g., to self-park). For example the ECU 120 residing in the vehicle 105 can receive an indication via a computing network that there are no available parking spaces, or can determine that there are no available parking spaces based on input received from object detection or other sensors of the vehicle 105. The speech module 115 can provide or transmit a notification (e.g., via a communication module 155 of the speech module 115) to the user responsive to the indication. The speech module 115 can provide or transmit a notification via an electronic transmission (e.g., an email or text message), or via an audio indicator or visual indicator, as described above. For example, the speech module 115 can transmit the notification via the communication module 155, or instruct a telematics ECU 120A to transmit the notification. The notification can include at least one of: a response or message indicating that the vehicular function cannot be performed, providing a reason that the vehicular function cannot be performed (e.g., no parking spots nearby), and providing at least one alternative to the vehicular function (e.g., to drive home and park the car at home), for example.

Various operations or acts of the method 200 can proceed according to various scenarios, for instance in accordance with the operational command issued by the user and identified by the speech module 115. Various scenarios provided herein are by way of illustration and not intended to be limiting in any way.

The speech module 115 can determine that a vehicular function corresponding to a received operational command includes or corresponds to performing autonomous parking (or self-parking) for example. The operational command can for example specify or provide instructions regarding at least one of: a garage or location at which to park, a distance range within which to park, a description of a preferred parking spot (e.g., a shady or sunny spot, within 5 minutes' drive away from a present location, minimize parking fees), a duration for parking, to charge the vehicle 105 while parked, to perform an action after parking for a specified duration (e.g., to pick up the user at a certain time, to inform the user of the parking location, and to remind the user to leave at the certain time, to find out a location of the user at a specific time).

The speech module 115 can activate a first ECU 120, the first ECU 120 comprising or corresponding to an autonomous parking ECU 120 corresponding to the determined vehicular function, to perform the autonomous parking. For example, the communication module 115 of the speech module 115 can activate the first ECU 120 (e.g., if the first ECU 120 is not in active mode, for instance when the vehicle 105 is parked or has been powered down). The communication module 115 of the speech module 115 can activate the first ECU 120 to bring the first ECU 120 out of a low power or inactive module. The speech module 115 can activate the first ECU 120 and communicate instruction(s) corresponding to the operational command and vehicular function to the first ECU 120, to perform the vehicular function. In instances where the vehicle 105 is already started or remains powered up or partially powered up (e.g., while idling or when the occupants have just exited the vehicle 105), the communication module 115 of the speech module 115 can communicate instruction(s) corresponding to the operational command and vehicular function to the first ECU 120, to perform the vehicular function.

The first ECU 120 can transition into active mode (if not already in active mode), responsive to an instruction from the communication module 155 to be activated. The first ECU 120 can initiate, perform and complete the vehicular function, responsive to the instruction(s) from the communication module 155 corresponding to the operational command and vehicular function to the first ECU 120. For example, where the vehicular function is to include parking the vehicle 105 in the vicinity, the first ECU 120 can activate and instruct a navigational module (e.g., of the telematics ECU 120A) to locate possible parking locations, can actuate and direct a self-driving ECU 120 of the vehicle 105 to drive the vehicle 105 to one or more of the possible parking locations, can actuate and use one or more sensors of the vehicle 105 to detect an available parking spot at one of the possible parking location, can position the vehicle 105 into the available parking spot, and can activate and instruct a telematics ECU 120A or payments ECU 120 of the vehicle 105 to perform a payments transaction for the parking. The first ECU 120 can send a notification to a device (e.g., a smart phone, laptop, key fob, and so on) of the user responsive to completion of the autonomous parking (or one or more stages of the autonomous parking). The first ECU 120 can send a notification including a time stamp of the completion and location information of the vehicle 105. For example, the first ECU 120 can send a notification (e.g., including location details and timestamp) responsive to parking the vehicle 105 at the available parking spot, can send a notification (e.g., including payment and location details, and timestamp) responsive to completing a payment for the parking or to leaving the parking spot.

The speech module 115 can determine that the vehicular function corresponding to the operational command includes a vehicular function to pick up the user at a specified time (e.g., after self-parking). The operational command can be for the vehicle 105 to self-park and return to pick up the user at a given time, e.g., “go park and pick me up at 4 pm”. For instance, the user drives to the user's destination in the vehicle 105, exits the vehicle 105 and closes the door of the vehicle 105. The user can issue a voice command 160 including the activation phrase to engage the speech module 115. The speech module 115 can recognize the voice of the user via the activation phrase, and identifies or authenticates the user as having proper access rights to issue an operational command to the vehicle 105. The speech module 115 can acknowledge the voice command 160 or indicate the authentication via an indicator (e.g., lighting and sound notifications). For example, the speech module 115 can cause an external speaker of the vehicle 105 to acknowledge the voice command 160 by an audible message “OK, I will park and pick you up at 4 pm. Parking now.” The speech module 115 can instruct the autonomous parking ECU 120 to drive the vehicle 105 to a parking spot.

The speech module 115 can provide instructions to a pick-up ECU 120 to schedule and perform the pick-up (as part of the vehicular function). In one example, the speech module 115 can instruct the pick-up ECU 120 to communicate with a device of the user to determine a location of the user proximate to the specified time, and to control the vehicle 105 to drive to the location of the user at the specified time. The pick-up ECU 120 can include or interoperate with one or more ECUs 120 of the vehicle 105 to perform the vehicular function, and can be a component of the speech module 115 for instance. The pick-up ECU 120 can send a message to a device (e.g., a smart phone, laptop, key fob, and so on) of the user prior to the pick-up time (e.g., 15 minutes, 30 minutes, or some other time prior to the pick-up time), to request, obtain and confirm a location of the user for the pick-up. Upon receiving the location of the user from the device of the user, the pick-up ECU 120 can calculate or estimate a trip duration to drive to the location of the user, and can determine a time to start driving to the location, so as to reach the specified pick-up time on time.

At the determined time to start, the pick-up ECU 120 can direct the vehicle 105 to autonomously drive to the location. The pick-up ECU 120 can send a message to the user's device when the vehicle 105 is on the way to the location for the pick-up. For instance, the pick-up ECU 120 can continuously or intermittently cause a telematics ECU 120A of the vehicle 105 to communicate with a mobile application executing on the user's device, to allow the mobile application to track and display the status of the vehicle 105 (e.g., location on map, time to arrival, distance to arrival, in real-time). The pick-up ECU 120 can cause the telematics ECU 120A to communicate with the mobile application to track the user's location in real-time, so as modify the pick-up location where appropriate. In arriving at the location for the pick-up, the pick-up ECU 120 can cause an indicator (e.g., lights of the vehicle 105) to alert the user, and can send a notification to the mobile application for instance. When the user is next to the vehicle 105, the user can issue a voice command 160 that includes an operational command to instruct the vehicle 105 to open a door to allow the user to enter. For example, the speech module 115 can process the operational command as described herein, and can send an instruction to a door ECU 120 of the vehicle 105 to unlock and open the door. The door ECU 120 can actuate a lock of the door to unlock, and can actuate a hydraulic mechanism at the door to open the door.

The speech module 115 can determine that the vehicular function corresponding to the operational command includes to perform electrical charging of the vehicle 105 and to perform autonomous parking. Using the autonomous parking example described herein, the speech module 115 can activate and instruct (via the communication module 155) a navigational module (e.g., of the telematics ECU 120A) to locate possible locations (e.g., parking locations) with a charging port, can actuate and direct a self-driving ECU 120 of the vehicle 105 to drive the vehicle 105 to one or more of the possible locations, can actuate and use one or more sensors of the vehicle 105 to detect an available charging port at one of the possible locations, can autonomously park the vehicle 105 at a parking spot and engage the vehicle 105 with the available charging port, and can activate and instruct a telematics ECU 120A or payments ECU 120 of the vehicle 105 to perform a payments transaction for the charging (if payment is required. The speech module 115 can activate and instruct (via the communication module 155) another ECU 120 comprising an electrical charging ECU 120, to perform the electrical charging of the vehicle 105 at the location where the vehicle 105 completed the autonomous parking. The electrical charging ECU 120 can cause the vehicle 105 to connect with the charging port and to accept electrical charging from the charging port. The speech module 115 or the telematics ECU 120A can send a notification to a device (e.g., a smart phone, laptop, key fob, and so on) of the user responsive to the start or completion of one or more stages of the electrical charging of the vehicle 105 and the autonomous parking. For example, the telematics ECU 120A can send a notification to a device of the user responsive to completion of the electrical charging. The notification can include a time stamp of the completion of the electrical charging and location information of the vehicle 105.

The speech module 115 can cause the electrical charging to intermittently or continuously communicate (e.g., via the telematics ECU 120A) with the mobile application to provide a status of the electrical charging to the user (e.g., remaining charging time, vehicle battery charge level). A user can also use the voice command 160 interface of the user's device to issue a voice command 160 to get an update from the vehicle 105 on the status of the charging and other details. The speech module 115 can receive the voice command 160 wirelessly communicated to the telematics ECU 120A of the vehicle 105, and can process an operational command of the voice command 160. In respond to the operational command to report a status, the speech module 115 can instruct the electrical charging ECU 120 to provide the status, and can instruct the telematics ECU 120 to send the status to the user's device.

The speech module 115 can determine that the vehicular function corresponding to the operational command includes a vehicular function to control an interior temperature of the vehicle 105 to a specified setting. The speech module 115 can activate an ECU 120 comprising a heating, ventilation and air conditioning (HVAC) ECU 120, to cool or heat an interior of the vehicle 105 to the specified setting. For instance, a user can walk close to the vehicle 105 which is parked under the sun on a hot day. The user knows that the interior of the car is going to be hot. The user can issue a voice command 160 to cool down the vehicle 105, e.g., “OK Car, cool down to 65 degrees.” The speech module 115 can recognize the voice of the user via the activation phrase “OK Car”, and identifies or authenticates the user as having proper access rights to issue an operational command to the vehicle 105. The speech module 115 can acknowledge the voice command 160 or indicate the authentication via an indicator (e.g., lighting and sound notifications). For example, the speech module 115 can cause an external speaker of the vehicle 105 to acknowledge the voice command 160 by an audible message “OK, I will cool the cabin and let you know.”

The speech module 115 can instruct the HVAC ECU 120 to turn on an air-conditioning unit of the vehicle 105, to cool down the cabin to 65 degrees, and to provide a signal to the speech module 115 when the target temperature is reached. The speech module 115 can provide an indication to the user responsive to the interior of the vehicle 105 reaching the specified setting. For example, upon detecting that the cabin temperature has reached 65 degrees, the HVAC ECU 120 can send a signal to the speech module 115, to cause the speech module 115 to provide a notification to the user (e.g., via an audible message “Hi, the cabin is at 65 degrees”). The user can issue a voice command 160 with an operational command to unlock and open a door of the vehicle 105 for entry into the cabin.

The speech module 115 can determine that a vehicular function corresponding to an operational command includes a vehicular function to control an open, close or retract operation on a door, window, trunk, frunk, sunroof, hatch, cover or roof of the vehicle 105. The speech module 115 can activate the first ECU 120 to control the open, close or retract operation. By way of an example, a user approaches a rear end of a vehicle 105 with both hands busy or occupied with packages. The user can issue a voice command 160 to the vehicle 105 to open the trunk, e.g., “Hey Car, open the trunk.” The speech module 115 can recognize the voice of the user via the activation phrase “Hey Car”, and identifies or authenticates the user as having proper access rights to issue an operational command to the vehicle 105. The speech module 115 can acknowledge the voice command 160 or indicate the authentication via an indicator (e.g., lighting and sound notifications). For example, the speech module 115 can cause the rear lights of the vehicle 105 to blink to acknowledge the voice command 160. The speech module 115 can instruct an ECU 120 corresponding to a trunk ECU 120 to unlock and open the trunk. The truck ECU 120 can actuate a latch of the trunk to unlock, and can actuate a motor of the trunk to open the trunk.

The user can unload the packages into the trunk and can issue another voice command 160 to the vehicle 105 to close and lock the trunk (e.g., “Hey Car, close and lock the trunk”). The speech module 115 can recognize the voice of the user via the activation phrase “Hey Car”, and identifies or authenticates the user as having proper access rights to issue an operational command to the vehicle 105. The speech module 115 can acknowledge the voice command 160 or indicate the authentication via an indicator (e.g., blinking of rear lights of the vehicle 105). The speech module 115 can instruct the trunk ECU 120 to close and lock the trunk. The truck ECU 120 can actuate the motor of the trunk to close the trunk, and can actuate the latch of the trunk to lock the trunk.

By way of another example, a user can park the user's car on a sunny day under the sun in a place the user feels safe to leave the car. The user exits the car and closes the door of the car, but then decides to leave the windows and sun roof slightly open so that the car does not get too hot inside. Instead of entering the car to operate the window and sun roof controls in the cabin, the user can say a voice command 160 to crack open the windows and the sun roof slightly open (e.g., “OK Car, crack open the windows and roof”). The speech module 115 can recognize the voice of the user via the activation phrase “OK Car”, and identifies or authenticates the user as having proper access rights to issue an operational command to the vehicle 105. The speech module 115 can acknowledge the voice command 160 or indicate the authentication via an indicator. For example, the speech module 115 can cause an audible message to be output via an exterior speaker (e.g., OK, leaving the windows and sun roof slightly open). The speech module 115 can instruct an ECU 120 to open the windows and the sun roof. The ECU 120 can actuate motors of the windows and the sun roof to leave an opening of an inch (or other size or extent) for instance.

FIG. 3, among others, depicts a block diagram of an example computer system 300. The computer system or computing device 300 can include or be used to implement the speech module 115, the ECU(s) 120, and the server(s) 130, or their components. The computing system 300 includes at least one bus 305 or other communication component for communicating information and at least one processor 310 or processing circuit coupled to the bus 305 for processing information. The computing system 300 can also include one or more processors 310 or processing circuits coupled to the bus for processing information. The computing system 300 also includes at least one main memory 315, such as a random access memory (RAM) or other dynamic storage device, coupled to the bus 305 for storing information, and instructions to be executed by the processor 310. The main memory 315 can be or include the memory storage unit 145. The main memory 315 can also be used for storing position information, vehicle information, command instructions, vehicle status information, environmental information within or external to the vehicle 105, road status or road condition information, or other information during execution of instructions by the processor 310. The computing system 300 can include at least one read only memory (ROM) 320 or other static storage device coupled to the bus 305 for storing static information and instructions for the processor 310. A storage device 325, such as a solid state device, magnetic disk or optical disk, can be coupled to the bus 305 to persistently store information and instructions. The storage device 325 can include or be part of the memory storage unit 145.

The computing system 300 may be coupled via the bus 305 to a display 335, such as a liquid crystal display, or active matrix display, for displaying information to a user such as a driver of the electric vehicle 105. An input device 330, such as a keyboard or voice interface may be coupled to the bus 305 for communicating information and commands to the processor 310. The input device 330 can include a touch screen display 335. The input device 330 can also include a cursor control, such as a mouse, a trackball, or cursor direction keys, for communicating direction information and command selections to the processor 310 and for controlling cursor movement on the display 335. The display 335 can be part of the speech module 115, or an infotainment unit of the vehicle 105 in FIG. 1.

The processes, systems and methods described herein can be implemented by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement may also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., the ECUs 120 and components of the speech module 115), and illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “data processing system” “computing device” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, while vehicle 105 can include electric, fossil fuel or hybrid vehicles in addition to electric powered vehicles as well as autonomous, semi-autonomous, and non-autonomous or manually operated vehicles. Scope of the systems and methods described herein is thus indicated by the appended claims, rather than the foregoing description, and changes that come within the meaning and range of equivalency of the claims are embraced therein.

What is claimed is:

1. A system to control vehicular functions using voice commands that originate outside vehicles, comprising:
at least one of a plurality of microphones disposed on an exterior of a vehicle, to:
detect a voice command from a user located outside the vehicle, the voice command comprising an activation phrase followed by an operational command;
activate, responsive to the detection, a speech module of the vehicle from a low-power mode, the speech module having a processor and a memory storage unit; and
the speech module to execute the processor and use the memory storage unit to:
authenticate the user according to the activation phrase of the voice command;
determine a vehicular function corresponding to the operational command of the voice command;
cause the vehicle to provide an indicator to acknowledge the operational command, responsive to authenticating the user; and
activate, responsive to authenticating the user, a first electronic control unit (ECU) of a plurality of ECUs of the vehicle that corresponds to the vehicular function, to perform the vehicular function.

2. The system of claim 1, comprising:
the speech module to select the first ECU according to the vehicular function, and to provide an instruction to the first ECU to perform the vehicular function; and
the first ECU to perform the vehicular function responsive to the instruction.

3. The system of claim 1, comprising:
the speech module to match a portion of the voice command with a defined phrase, the portion of the voice command corresponding to the activation phrase, and to biometrically match the activation phrase with an enrolled recording of the user.

4. The system of claim 1, comprising:
the first ECU to determine that the first ECU cannot perform the vehicular function, and to indicate to the speech module that the first ECU cannot perform the vehicular function; and
the speech module to provide a notification to the user responsive to the indication, the notification comprising at least one of: a response that the vehicular function cannot be performed, a reason that the vehicular function cannot be performed, and an alternative to the vehicular function.

5. The system of claim 1, comprising the speech module to:
cause the vehicle to provide an indicator to acknowledge the operational command;
detect, subsequent to the indicator, another voice command comprising another operational command to cancel the operational command acknowledged by the indicator; and
instruct the first ECU to cancel the vehicular function.

6. The system of claim 1, comprising:
the at least one of the plurality of microphones to record the voice command in the memory storage unit; and
the speech module to:
access, upon activation from the low power mode, the recorded voice command from the memory storage unit;
parse the recorded voice command for the activation phrase to authenticate the user; and
parse the recorded voice command for the operational command to determine the vehicular function.

7. The system of claim 1, comprising:
the at least one of the plurality of microphones to record a plurality of voice commands from the user in the memory storage unit; and
the speech module to:
use the plurality of voice commands to train a model to at least one of: recognize the activation phrase from the plurality of voice commands, recognize the user according to the activation phrase from the plurality of voice commands, and determine operational commands from the plurality of voice commands; and
use the model to at least one of: recognize the activation phrase from the voice command, recognize the user according to the activation phrase, and determine the operational command from the voice command.

8. The system of claim 1, comprising:
the speech module to activate a natural speech processing engine from a low power mode of the natural speech processing engine; and
the natural speech processing engine to determine the vehicular function corresponding to the operational command of the voice command.

9. The system of claim 1, comprising the speech module to:
communicate the operational command of the voice command to a command processing engine executing on a server; and
determine, in communication with the command processing engine, the vehicular function corresponding to the operational command of the voice command.

10. The system of claim 1, comprising the speech module to:
determine that the vehicular function corresponding to the operational command comprises to perform autonomous parking;
activate the first ECU comprising an autonomous parking ECU corresponding to the determined vehicular function, to perform the autonomous parking; and
send a notification to a device of the user responsive to completion of the autonomous parking, the notification including a time stamp of the completion and location information of the vehicle.

11. The system of claim 10, comprising the speech module to:
determine that the vehicular function corresponding to the operational command comprises to perform electrical charging of the vehicle and to perform the autonomous parking;
activate a second ECU comprising an electrical charging ECU, to perform the electrical charging of the vehicle at a location where the vehicle completed the autonomous parking; and
send a notification to a device of the user responsive to completion of the electrical charging, the notification including a time stamp of the completion of the electrical charging and the location information of the vehicle.

12. The system of claim 1, comprising the speech module to:
determine that the vehicular function corresponding to the operational command comprises to pick up the user at a specified time; and
instruct the first ECU to communicate with a device of the user to determine a location of the user proximate to the specified time, and to control the vehicle to drive to the location of the user at the specified time.

13. The system of claim 1, comprising the speech module to:
determine that the vehicular function corresponding to the operational command comprises to control an interior temperature of the vehicle to a specified setting;
activate, the first ECU comprising a heating, ventilation and air conditioning (HVAC) ECU, to cool or heat an interior of the vehicle to the specified setting; and
provide an indication to the user responsive to the interior of the vehicle reaching the specified setting.

14. The system of claim 1, comprising the speech module to:
determine that the vehicular function corresponding to the operational command comprises to control an open, close or retract operation on a door, window, trunk, frunk, sunroof, hatch, cover or roof of the vehicle; and
activate the first ECU to control the open, close or retract operation.

15. The system of claim 1, comprising:
the speech module to at least one of activate the speech module of the vehicle, authenticate the user, and activate the first ECU, without involving a key, fob or personal device of the user.

16. A method to control vehicular functions using voice commands that originate outside vehicles, comprising:
detecting, by at least one of a plurality of microphones disposed on an exterior of a vehicle, a voice command from a user located outside the vehicle, the voice command comprising an activation phrase followed by an operational command;
activating, responsive to the detection, a speech module of the vehicle from a low-power mode of the speech module;
authenticating, by the speech module, the user according to the activation phrase of the voice command;
determining, by the speech module, a vehicular function corresponding to the operational command of the voice command;
providing an indicator to acknowledge the operational command, responsive to authenticating the user; and
activating, by the speech module responsive to authenticating the user, a first electronic control unit (ECU) of a plurality of ECUs of the vehicle that corresponds to the vehicular function, from a low power mode of the first ECU to perform the vehicular function.

17. The method of claim 16, wherein the indicator to acknowledge the operational command includes at least one of an audio indicator and a visual indicator.

18. The method of claim 16, comprising:
providing a notification to the user responsive to completion of the determined vehicular function, the notification comprising:
an electronic transmission to a device of the user when the user is beyond a vicinity of the vehicle, and
at least one of an audio and a visual indicator from the vehicle when the user is in a vicinity of the vehicle.

19. A vehicle, comprising:
at least one of a plurality of microphones disposed on an exterior of a vehicle, to:
detect a voice command from a user located outside the vehicle, the voice command comprising an activation phrase followed by an operational command;
activate, responsive to the detection, a speech module of the vehicle from a low-power mode, the speech module having a processor and a memory storage unit; and
the speech module to execute the processor and use the memory storage unit to:
authenticate the user according to the activation phrase of the voice command;
determine a vehicular function corresponding to the operational command of the voice command;
cause the vehicle to provide an indicator to acknowledge the operational command, responsive to authenticating the user; and
activate, responsive to authenticating the user, a first electronic control unit (ECU) of a plurality of ECUs of the vehicle that corresponds to the vehicular function, to perform the vehicular function

20. The vehicle of claim 19, comprising:
the at least one of the plurality of microphones to instruct, responsive to an absence of detected voice commands over a defined time period, at least one of: the speech module to enter the low power mode of the speech module, and the first ECU to enter the low power mode of the first ECU.
